(19) United States
(12) Patent Application Publication
(10) Pub. No.: US 2022/0257987 A1
(43) Pub. Date: Aug. 18, 2022

(54) INSULATED COVER FOR FIRE SPRINKLER

(71) Applicant: Thermal Structures, Inc., Corona, CA (US)

(72) Inventors: Gregory Martinez, Riverside, CA (US); Tony Garcia, Romoland, CA (US); Vaughn Barnes, Corona Del Mar, CA (US)

(21) Appl. No.: 17/671,332

(22) Filed: Feb. 14, 2022

Related U.S. Application Data
(60) Provisional application No. 63/149,222, filed on Feb. 13, 2021.

(51) Int. Cl. A62C 35/68; B05B 15/16

(52) U.S. Cl. CPC A62C 35/68; B05B 15/16

(57) ABSTRACT

Collapsible insulated covers for devices (e.g., fire sprinklers) are contemplated. The collapsible insulated covers have one or more couplers configured to couple a device. The collapsible insulated covers collapse to thereby position the one or more to couple the device. It is contemplated that the collapsible insulated covers can create one or more seals that reduce heat transfer into its interior space (i.e., pocket) where the device or a portion of the device is placed for thermal insulation.

This application claims priority to U.S. Provisional Application Ser. No. 63/149,222, titled “Insulated Cover For Fire Sprinkler” and filed Feb. 13, 2021. All extrinsic materials identified herein are incorporated by reference in their entirety.

### FIELD OF THE INVENTION

The field of the invention is insulated covers for fire sprinklers and other devices.

### BACKGROUND

The background description includes information that may be useful in understanding the present invention. It is not an admission that any of the information provided herein is prior art or relevant to the presently claimed invention, or that any publication specifically or implicitly referenced is prior art.

Rooms and other spaces may need to be heated to a high temperature as part of their maintenance. For example, a room (e.g., a hotel room) may need to be heated to a high temperature sufficient to kill bed bugs. A problem arises when the room or space has a fire sprinkler or other device that can be damaged or inadvertently activated (e.g., the fire sprinkler is activated and dispenses water) when exposed to a high temperature. One solution is to physically remove the fire sprinkler or other device. However, physical removal of the fire sprinkler or other device may not be practical.

Some have contemplated an insulated cover for a fire sprinkler. For example, Williams et al. (U.S. Pat. Pub. 2013/0043328) and Bedell (U.S. Pat. Pub. 2018/0355989) each disclose a device for insulating a fire sprinkler from excessive heat. These and all other extrinsic materials discussed herein are incorporated by reference in their entirety. Where a definition or use of a term in an incorporated reference is inconsistent or contrary to the definition of that term provided herein, the definition of that term provided herein applies and the definition of that term in the reference does not apply.

Although insulated covers have been contemplated, the inventors have found that existing designs can be further improved. Thus, there is still a need in the art for improved insulated overs for fire sprinklers and other devices.

### SUMMARY OF THE INVENTION

The inventive subject matter provides apparatus, systems, and methods in which a collapsible insulated cover can be used to provide thermal insulation for fire sprinklers and other devices. One contemplated insulated cover for a device (e.g., a fire sprinkler head) comprises a body and a shoulder. The shoulder extends from the body. At least a portion of the device can be inserted into a pocket of the insulated cover to thermally insulate the portion of the device. It is contemplated that the insulated cover is configured to collapse when the insulated cover is pushed against the device to thereby position one or more couplers to couple to the device.

The insulated cover can comprise inner and outer fabric layers, and an insulation material disposed between the inner and outer fabric layers. Additionally, or alternatively, a loop extends from the body of the insulated cover. The loop can be used to remove the insulated cover from the device by inserting (i) a finger of a user or (ii) a hook or pole through the loop, and pulling the insulated cover from the device.

The insulated cover can comprise a first coupler configured to couple the insulated cover to the device. The first coupler is a magnet, an adhesive, or a hook and loop fastener. In some embodiments, the first coupler is positioned on or within the shoulder.

Additionally, the insulated cover can comprise a second coupler configured to couple the insulated cover to the device. The second coupler is a magnet, an adhesive, or a hook and loop fastener. In some embodiments, the second coupler is positioned on or within the shoulder.

As described above, it is contemplated that the insulated cover is collapsible. In some embodiments, a first fold line is between the shoulder and the body to allow movement (e.g., rotation) of the shoulder and the body relative to one another. Additionally, a second fold line is between a ridge and the shoulder to allow movement (e.g., rotation) of the ridge and the shoulder relative to one another. In some embodiments, the shoulder and the body can move relative to one another via a hinge. Additionally, the shoulder and the ridge can move relative to one another via a second hinge.

In another aspect, an insulated cover for a fire sprinkler head coupled to an escutcheon is contemplated. The insulated cover comprises a body, shoulder, and a ridge. The body at least partially defines a pocket that is sized and dimensioned to receive the fire sprinkler head. The shoulder is movable relative to the body, and the ridge is movable relative to the shoulder. It is contemplated that a first coupler is disposed on or within the shoulder. The shoulder is configured to collapse into the pocket when the ridge is pushed against the escutcheon to thereby position the first coupler to couple the escutcheon.

The first coupler can be a magnet, an adhesive, or a hook and loop fastener. Additionally, it is contemplated that a second coupler can be disposed on or within the shoulder. In such embodiments, the shoulder is configured to position the second coupler to couple the escutcheon when the shoulder is collapsed into the pocket.

As described above, it is contemplated that the insulated cover is collapsible. In some embodiments, a first fold line is between the shoulder and the body to allow movement (e.g., rotation) of the shoulder and the body relative to one another. Additionally, a second fold line is between a ridge and the shoulder to allow movement (e.g., rotation) of the ridge and the shoulder relative to one another. In some embodiments, the shoulder and the body can move relative to one another via a hinge. Additionally, the shoulder and the ridge can move relative to one another via a second hinge.

Various objects, features, aspects and advantages of the inventive subject matter will become more apparent from the following detailed description of preferred embodiments, along with the accompanying drawing figures in which like numerals represent like components.

### BRIEF DESCRIPTION OF THE DRAWINGS

FIG. 1 is a perspective view of an embodiment of an insulated cover.

FIG. 2 is a side view of the insulated cover of FIG. 1.

FIG. 3 is another side view of the insulated cover of FIG. 1.

FIG. 4 is a cross-sectional view along the line 4-4 in FIG. 1 of the insulated cover of FIG. 1.

FIG. 5 is a perspective view of an embodiment of an insulated cover.

FIG. 6 is a side view of the insulated cover of FIG. 5.

FIG. 7 is a perspective view of the insulated cover of FIG. 5 in a collapsed configuration.

FIG. 8 is a side view of the insulated cover of FIG. 5 in a collapsed configuration.

FIG. 9 is a side view of the insulated cover of FIG. 5 below a fire sprinkler head and an escutcheon.

FIG. 10 is a side view of the insulated cover of FIG. 5 having the fire sprinkler head inside the insulated cover.

FIG. 11 is a side view of the insulated cover of FIG. 5 in a collapsed configuration.

FIG. 12 is a side view of the insulated cover of FIG. 5 in a collapsed configuration against a ceiling.

### DETAILED DESCRIPTION

The following discussion provides example embodiments of the inventive subject matter. Although each embodiment represents a single combination of inventive elements, the inventive subject matter is considered to include all possible combinations of the disclosed elements. Thus if one embodiment comprises elements A, B, and C, and a second embodiment comprises elements B and D, then the inventive subject matter is also considered to include other remaining combinations of A, B, C, or D, even if not explicitly disclosed.

The inventors have developed light weight insulated covers that provide thermal insulation for fire sprinklers and other devices. In some embodiments, the insulated cover comprises one or more magnets to couple the insulated cover onto a fire sprinkler or other device. The one or more magnets can be disposed between inner and outer layers of the insulated cover. It should be appreciated that such placement of the one or more magnets reduces the risk that the one or more magnets is lost (e.g., the magnet remains inadvertently coupled to the fire sprinkler or other device, the magnet detaches from insulated cover, etc.) after the insulated cover is removed from the device. The inventors have found this problem in other systems having magnets disposed on the outer surface, and the adhesive or other fastener between the magnet and insulated cover becomes worn or damaged causing the magnet to remain coupled to the fire sprinkler when the insulated cover is removed from the fire sprinkler. Additionally, it should be appreciated that placing the one or more magnets between the outer and inner layers of the insulated cover protects the one or more magnets against the environment external to outer layer of the insulated cover.

Furthermore, it is contemplated that the insulated covers collapse to provide a secure coupling with a fire sprinkler or other device. In some embodiments, the insulated cover has a ridge that is pressed against a portion of the fire sprinkler or other device to thereby collapse a shoulder of the insulated cover and position one or more couplers of the insulated cover to couple the fire sprinkler or other device. It is contemplated that the one or more couplers secure the insulated cover onto the fire sprinkler or other device, and keep the ridge pressed against the portion of the fire sprinkler or other device. A first seal that reduces thermal energy into an interior volume of the insulated cover can be formed while the ridge presses against the portion of the fire sprinkler or other device. It is contemplated that a second seal that reduces thermal energy into the interior volume of the insulated cover can be formed while the shoulder and/or the body of the insulated cover presses against a second portion of the fire sprinkler or other device.

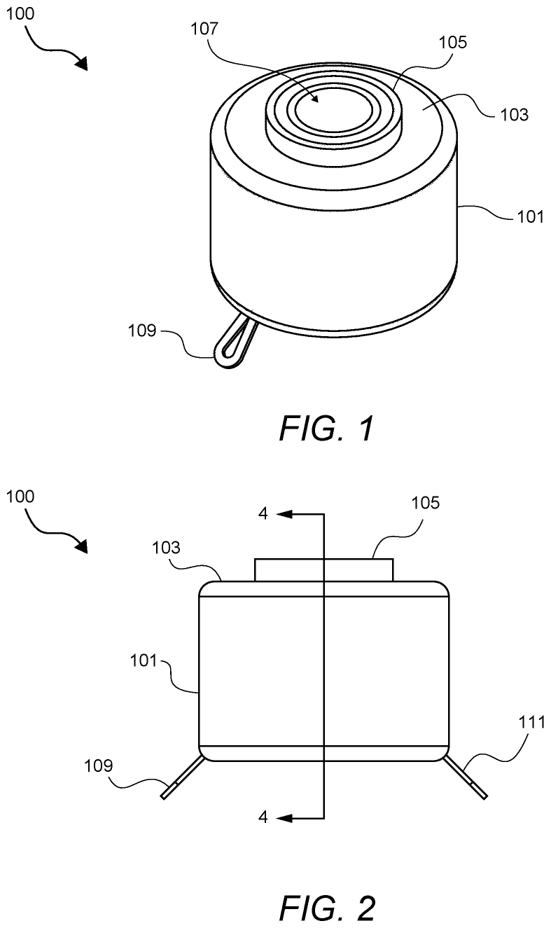

An embodiment of an insulated cover 100 for a device (e.g., a fire sprinkler) is shown in FIG. 1. Insulated cover 100 comprises a body 101, a shoulder 103, and a ridge 105. Shoulder 103 extends from body 101, and ridge 105 extends from shoulder 103. Ridge 105 defines an opening 107 into insulated cover 100. It is contemplated that a device or a portion of a device (e.g., a fire sprinkler head) can be inserted into opening 107 for thermal insulation.

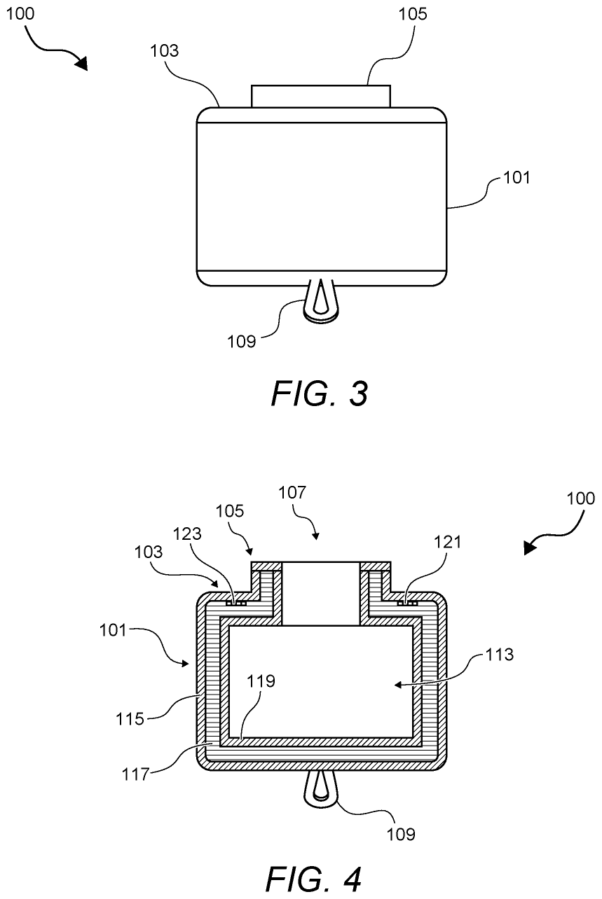

As shown in FIGS. 2-3, ridge 105 can extend upwardly from shoulder 103. Insulated cover can comprise a first loop 109 that extends from body 101. It is contemplated that a user can insert a finger or a pole or a hook through first loop 109 to pull and remove insulated cover 100 from a device. Insulated cover 100 can comprise a second loop 111 that extends from body 101. Similarly, it is contemplated that a user can insert a finger or a pole or a pole through second loop 111 to remove insulated cover 100 from a device.

As discussed above, a device or a portion of a device can be inserted into insulated cover 100 for thermal insulation. FIG. 4 shows a pocket 113 sized and dimensioned to receive at least a portion of a device. For example, it is contemplated pocket 113 is sized and dimensioned to receive a fire sprinkler head. In such embodiment, the fire sprinkler head can be inserted into pocket 113 through opening 107 for thermal insulation.

Insulated cover 100 comprises an inner layer 119 and an outer layer 115. Insulation material 117 can be disposed between inner layer 119 and outer layer 115. It is contemplated that inner layer 119 and/or outer layer 115 is a fabric.

Insulated cover 100 can be coupled to a device to provide thermal insulation. It is contemplated that a first coupler 121 is disposed on or within shoulder 103 to thereby couple insulated cover 100 to a device. First coupler 121 can be a magnet, an adhesive, or a hook and loop fastener. For example, first coupler 121 can be a magnet disposed in shoulder 103 as shown in FIG. 4. It is contemplated that first coupler 121 can couple with a portion of a fire sprinkler (e.g., a fire sprinkler escutcheon) to thereby couple insulated cover 100 with the fire sprinkler.

Additionally, it is contemplated that a second coupler 123 is disposed on or within shoulder 103 to thereby couple insulated cover 100 to a device. Second coupler 123 can be a magnet, an adhesive, or a hook and loop fastener. For example, second coupler 123 can be a magnet disposed in shoulder 103 as shown in FIG. 4. It is contemplated that second coupler 123 can couple with a portion of a fire sprinkler (e.g., a fire sprinkler escutcheon) to thereby couple insulated cover 100 with the fire sprinkler.

It is contemplated that first coupler 121 and/or second coupler 123 can be disposed between inner layer 119 and outer layer 115. For example, first coupler 121 and/or second coupler 123 can be disposed between outer layer 115 and insulation material 117, within insulation material 117, or between insulation material 117 and inner layer 119. In such embodiments, it should be appreciated that inner layer 119, insulation material 117, and/or outer layer 115 can (i) shield first coupler 121 and/or second coupler 123 from environmental conditions (e.g., high temperatures) and (ii) hold first coupler 121 and/or the second coupler 123 within insulated cover 100 to prevent first coupler 121 and/or second coupler 123 from being lost or detached from insulated cover 100.

It is contemplated that one or more couplers can be disposed on other parts of insulated cover 100. For example, one or more couplers can be disposed on or within ridge 105. In such embodiments, the one or more couplers can be configured to couple with a portion of a fire sprinkler to thereby couple insulated cover 100 with the fire sprinkler. As noted above, suitable couplers are a magnet, an adhesive, or a hook and loop fastener. Additionally, or alternatively, one or more couplers can be disposed on or within body 101. In such embodiments, it is contemplated that the one or more couplers are configured to couple with a coupler disposed on a reach device (e.g., a pole) used to install or remove insulated cover 100 onto a device (e.g., a fire sprinkler) in a hard-to-reach area (e.g., a ceiling).

As discussed above, first coupler 121 and second coupler 123 can be configured to couple to a device (e.g., a fire sprinkler). FIG. 4 shows first coupler 121 and second coupler 123 within shoulder 103. It is contemplated that a portion of a device can be inserted into pocket 113 of insulated cover 100 for thermal insulation. As the portion of the device is inserted into pocket 113, ridge 105 can push against another portion of the device thereby causing shoulder 103 to collapse into pocket 113 and position first coupler 121 and/or second coupler 123 to couple the device.

As an example, a fire sprinkler head can be inserted into pocket 113 for thermal insulation. This may be desired when the fire sprinkler head is at risk of being exposed to a temperature high enough to inadvertently activate the fire sprinkler. As fire sprinkler head is inserted into pocket 113, ridge 105 abuts a fire sprinkler escutcheon and shoulder 103 is thereby caused to collapse into pocket 113. As shoulder 103 collapses into pocket 113, first coupler 121 and second coupler 123 are positioned to couple portions of the first sprinkler escutcheon. It is contemplated that first coupler 121 and second coupler 123 couple onto the first sprinkler escutcheon to thereby maintain ridge 105 pressed against the first sprinkler escutcheon. In some embodiments, a seal that reduces heat transfer into pocket 113 is created as ridge 105 is pressed against the fire sprinkler escutcheon. Additionally, or alternatively, it is contemplated that a seal that reduces heat transfer into pocket 113 is created as shoulder 103 and/or body 101 is pressed against the fire sprinkler escutcheon due to the coupling of first coupler 121 and/or second coupler 123 with the fire sprinkler escutcheon.

Depending on the design of the fire sprinkler, it is contemplated that ridge 105 can press against a portion of the fire sprinkler other than the fire sprinkler escutcheon to thermally insulate the fire sprinkler head from the environment. Similarly, it is contemplated that shoulder 103 and/or body 101 can press against a portion of the fire sprinkler other than the fire sprinkler escutcheon to thermally insulate the fire sprinkler head from the environment.

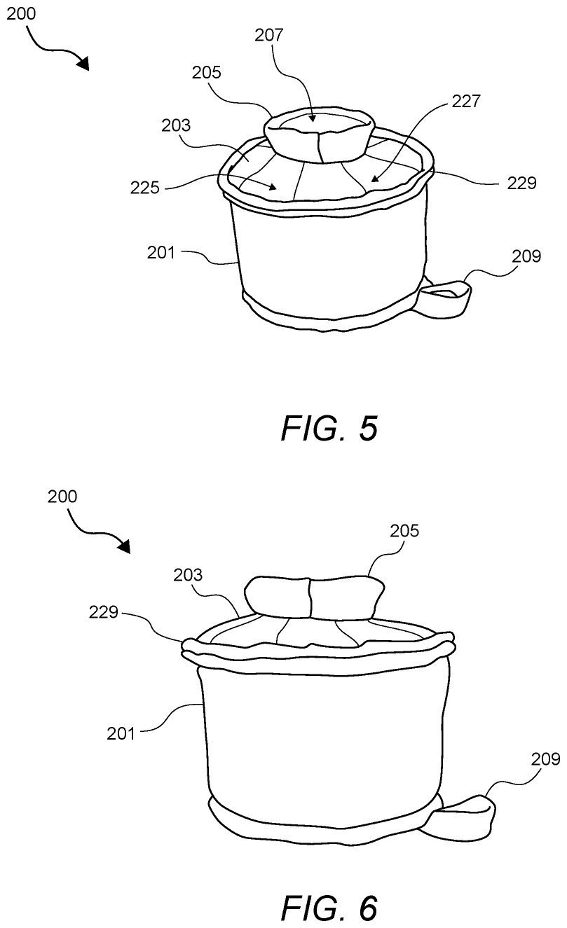

FIG. 5 shows an embodiment of an insulated cover 200 for a device (e.g., a fire sprinkler). Insulated cover 200 comprises a body 201, a shoulder 203, and a ridge 205. It is contemplated that shoulder 203 is movable relative to body 201. Additionally, or alternatively, it is contemplated that ridge 205 is movable relative to shoulder 203. A first coupler is disposed on or within shoulder 203. Ridge 205 forms an opening 207 through which the device or a portion of the device can be inserted into insulated cover 200 for thermal insulation. The interior volume of insulated cover 200 is referred to as a pocket (see, e.g., pocket 113). Insulated cover 200 can be coupled to the device via one or more couplers. A loop 209, also shown in FIG. 6, can be used to remove insulated cover 200 from the device.

Insulated cover 200 can comprise inner and outer layers with an insulation material disposed between the layers. Shoulder 203 can comprise compartments in which a coupler is housed. For example, shoulder 203 comprises a first compartment 225 and a second compartment 227. It is contemplated that each compartment can be separated from another compartment by a divider (e.g., stitching or an adhesive). A coupler can be disposed within each compartment or some compartments of shoulder 203. For example, it is contemplated that a first coupler (e.g., a magnet) is disposed within first compartment 225, and a second coupler (e.g., a magnet) is disposed within second compartment 227. Such compartments help prevent the couplers from being lost, and act as a barrier against harm to the couplers due to environmental causes (e.g., a high temperature). Suitable couplers include a magnet, an adhesive, or a hook and loop fastener.

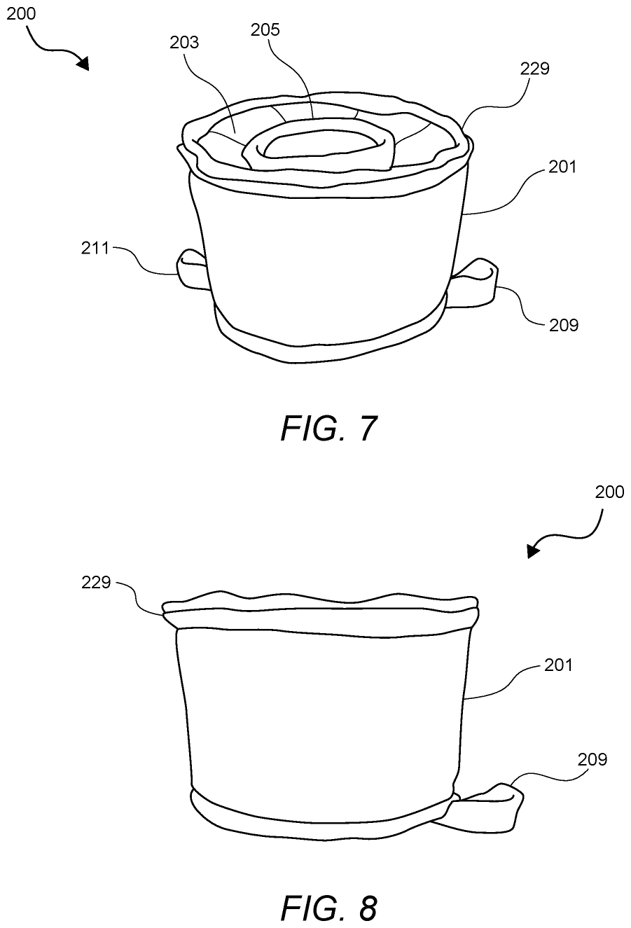

Insulated cover 200 is collapsible to thereby couple a device (e.g., a fire sprinkler). FIGS. 5-6 show insulated cover 200 in a non-collapsed configuration. When ridge 205 is pressed against a device to be thermally insulated, shoulder 203 and ridge 205 can collapse into the pocket of insulated cover 200 as shown in FIGS. 7 and 8. As shown in FIGS. 5-8, shoulder 203 and body 201 are movable relative to each other via a fold line 229 to thereby collapse into the pocket. Additionally, or alternatively, ridge 205 and shoulder 203 are movable relative to each other via a fold line (e.g., a fold line at the intersection between ridge 205 and shoulder 203 to allow movement). It is contemplated that a hinge can be used to provide movement between (i) ridge 205 and shoulder 203 and/or (ii) shoulder 203 and body 201.

It is contemplated that insulated cover 200 collapses to thereby position one or more couplers on or within shoulder 203 to thereby couple a portion of a device (e.g., a fire sprinkler escutcheon) to keep insulated cover 200 coupled to the device (e.g., fire sprinkler), and maintain (i) ridge 205 pressed against a portion of the device (e.g., a first portion of a fire sprinkler escutcheon) and/or (ii) shoulder 203 and/or body 201 pressed against a second portion of the device (e.g., a second portion of a fire sprinkler escutcheon). Insulated cover 200 can be removed using loop 209 or a second loop 211.

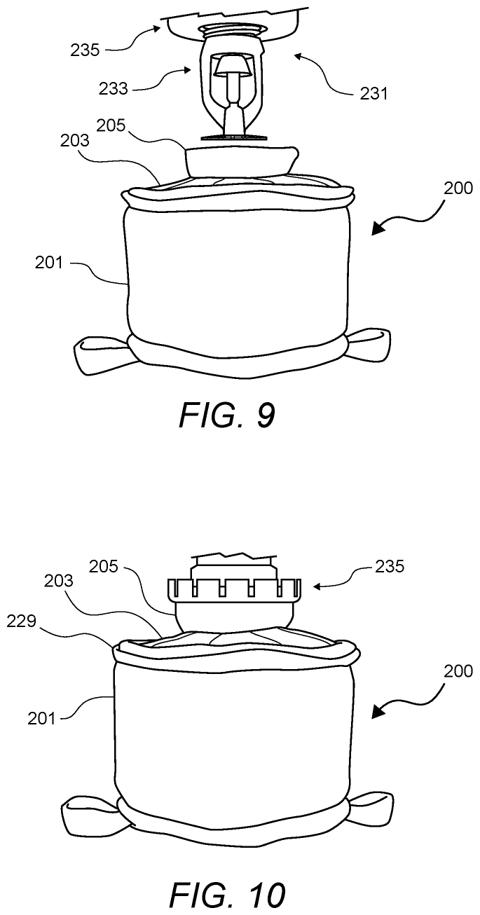

FIG. 9 shows insulated cover 200 below a fire sprinkler 231 having a fire sprinkler head 223 and a fire sprinkler escutcheon 235. Insulated cover 200 is positioned below fire sprinkler head 233 to align opening 207 with fire sprinkler head 233. Fire sprinkler head 233 is inserted into the pocket of insulated cover 200 through opening 207 as shown in FIG. 10. Ridge 205 abuts fire sprinkler escutcheon 235 and thermal insulation is provided to fire sprinkler head 233 within the pocket of insulated cover 200. It is contemplated that the abutment of ridge 205 against fire sprinkler escutcheon 235 can create a seal, which reduces heat transfer into the pocket of insulated cover 200.

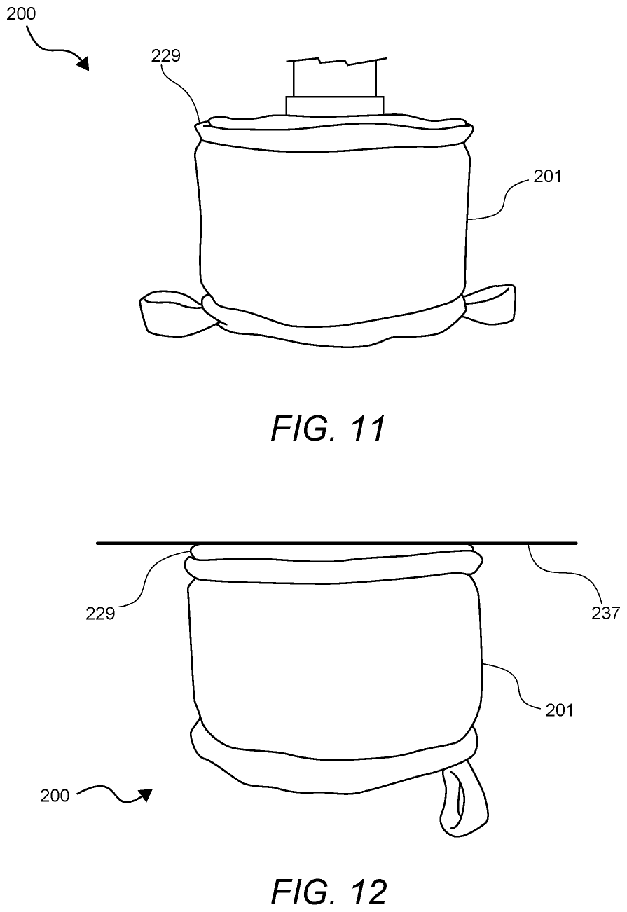

As insulated cover 200 is pushed upwardly into fire sprinkler 231, ridge 205 remains pressed against fire sprinkler escutcheon 235, shoulder 203 moves upward relative to ridge 205, and shoulder 203 moves downward relative body 201 to collapse into the pocket of insulated cover 200 as shown in FIG. 11 (see also collapsed configuration in FIG. 7). In the collapsed configuration, shoulder 203 is positioned relative to fire sprinkler escutcheon 235 to allow one or more couplers to couple fire sprinkler escutcheon 235. For example, shoulder 203 can comprise a first magnet in first compartment 225 and a second magnet in second compartment 227 that are each positioned to magnetically couple fire sprinkler escutcheon 235 when shoulder collapses into the pocket of insulated cover 200.

When coupled to fire sprinkler 231, it is contemplated that the abutment of shoulder 203 against fire sprinkler escutcheon 235 can create a seal, which reduces heat transfer into the pocket of insulated cover 200. In some instances, a ceiling 237 surrounds fire sprinkler 231 as shown in FIG. 12. Insulated cover 200 can still couple to fire sprinkler 231 to provide thermal insulation as shown in FIGS. 9-11. It is contemplated that shoulder 203 and/or body 201 can abut ceiling 237 when insulated cover 200 is coupled to fire sprinkler 231. It is further contemplated that the abutment of shoulder 203 and/or body 201 against ceiling 237 can create a seal, which reduces heat transfer into the pocket of insulated cover 200.

Insulation material in contemplated insulated covers can be disposed throughout the ridge, shoulder, and body of such insulated covers. However, it is also contemplated that insulation material can be disposed in select areas of the contemplated insulated covers (e.g., only in the body, only in the body and shoulder, only in the body and ridge, only in the shoulder and ridge, etc.).

It should be appreciated that contemplated insulated covers can be installed onto a fire sprinkler or other device on the ceiling without use of a ladder. For example, a reach tool with a grip head can be used to position contemplated insulated covers to couple such fire sprinkler or other device on the ceiling. It should further be appreciated that contemplated insulated covers can provide thermal insulation to a fire sprinkler escutcheon (see, e.g., FIGS. 11-12 showing fire sprinkler escutcheon 235 covered by insulated cover 200).

As described above, contemplated insulated covers can couple to a fire sprinkler or other devices via one or more couplers. For example, the one or more couplers can comprise one or more magnets that magnetically couple a portion of a fire sprinkler (e.g., a fire sprinkler escutcheon) or other device. In some embodiments, it is contemplated that a magnetic element (e.g., magnetic tape) can be placed on a portion of the fire sprinkler or other device to create a magnetic coupling with the one or more magnets of contemplated insulated covers. In other embodiments, contemplated insulated covers can comprise a magnetically attracted element (e.g., a ferromagnetic material, etc.) that thereby magnetically couple with a magnet disposed on a fire sprinkler or other device.

As used in the description herein and throughout the claims that follow, the meaning of “a,” “an,” and “the” includes plural reference unless the context clearly dictates otherwise. Also, as used in the description herein, the meaning of “in” includes “in” and “on” unless the context clearly dictates otherwise.

Also, as used herein, and unless the context dictates otherwise, the term “coupled to” is intended to include both direct coupling (in which two elements that are coupled to each other contact each other) and indirect coupling (in which at least one additional element is located between the two elements). Therefore, the terms “coupled to” and “coupled with” are used synonymously.

It should be apparent, however, to those skilled in the art that many more modifications besides those already described are possible without departing from the inventive concepts herein. The inventive subject matter, therefore, is not to be restricted except in the spirit of the disclosure. Moreover, in interpreting the disclosure all terms should be interpreted in the broadest possible manner consistent with the context. In particular the terms “comprises” and “comprising” should be interpreted as referring to the elements, components, or steps in a non-exclusive manner, indicating that the referenced elements, components, or steps can be present, or utilized, or combined with other elements, components, or steps that are not expressly referenced.

What is claimed is:

1. An insulated cover for a device, comprising:
a body;
a shoulder that extends from the body;
a first coupler disposed on or within the shoulder;
a pocket at least partially defined by the body; and
wherein at least a portion of the shoulder is configured to collapse into the pocket when the cover is pushed against the device to thereby position the first coupler to couple the device.

2. The insulated cover of claim 1, wherein the body comprises an insulation material.

3. The insulated cover of claim 2, wherein the body comprises inner and outer layers, and wherein the insulation material is disposed between the inner and outer layers.

4. The insulated cover of claim 1, further comprising a loop that extends from the body.

5. The insulated cover of claim 1, further comprising a ridge that extends from the shoulder and defines an opening into the pocket.

6. The insulated cover of claim 1, wherein the first coupler is a magnet, an adhesive, or a hook and loop fastener.

7. The insulated cover of claim 6, wherein the first coupler is a magnet.

8. The insulated cover of claim 7, wherein the shoulder comprises inner and outer layers, and wherein the magnet is disposed between the inner and outer layers.

9. The insulated cover of claim 1, wherein the pocket is sized and dimensioned to receive at least a portion of the device.

10. The insulated cover of claim 1, further comprising a second coupler disposed on or within the shoulder, and wherein the second coupler is positioned to couple the device when the at least portion of the shoulder collapses into the pocket.

11. The insulated cover of claim 1, wherein the shoulder and the body are configured to move relative to one another via a fold line or a hinge.

12. The insulated cover of claim 1, wherein the shoulder extends toward a center axis of the cover.

13. The insulated cover of claim 1, wherein the shoulder comprises (1) a first compartment having a first magnet, and (2) a second compartment having a second magnet.

14. An insulated cover for a fire sprinkler head coupled to an escutcheon, the insulated cover comprising:
a body that at least partially defines a pocket;
a shoulder that is movable relative to the body;
a ridge that is movable relative to the shoulder;
a first coupler disposed on or within the shoulder;
wherein the pocket is sized and dimensioned to receive the fire sprinkler head; and
wherein the shoulder is configured to collapse into the pocket when the ridge is pushed against the escutcheon to thereby position the first coupler to couple the escutcheon.

15. The insulated cover of claim 14, wherein the body comprises insulation material.

16. The insulated cover of claim 14, wherein the ridge defines an opening into the pocket, and wherein the opening has a width that is larger than a width of the fire sprinkler and smaller than a width of the escutcheon.

17. The insulated cover of claim 14, wherein the shoulder and the ridge are configured to move relative to one another via a fold line or a hinge.

18. The insulated cover of claim 14, further comprising a second coupler disposed on or within the shoulder, and wherein the shoulder is configured to position the second coupler to couple the escutcheon when the shoulder is collapsed into the pocket.

19. The insulated cover of claim 14, wherein the first coupler is a magnet, an adhesive, or a hook and loop fastener.

20. The insulated cover of claim 14, wherein the shoulder and the body are configured to move relative to one another via a fold line or a hinge.
